(19) United States
(12) Patent Application Publication
(10) Pub. No.: US 2009/0327911 A1
(43) Pub. Date: Dec. 31, 2009

(54) METHOD AND SYSTEM FOR CUSTOMIZING ACCESS TO A RESOURCE

(76) Inventors: Sanjay Ningune, (US); Jivan Madtha, (US); Yogesh Dandekar, (US); Tushar Kulkarni, (US)

Correspondence Address: JAY M. SCHLOFF, 6960 Orchard Lake Road, Suite 315, West Bloomfield, MI, 48322, US

(21) Appl. No.: 12/163,066

(22) Filed: Jun. 27, 2008

(51) Int. Cl. G06F 3/048

(52) U.S. Cl. 715/744

(57) ABSTRACT

Disclosed is a method and system for customizing access to a resource. The access to the resource is requested by users in a hierarchy. A first user of the users in the hierarchy is at a higher level in the hierarchy than a second user of the users in the hierarchy. The first user defines a role for the second user. The role includes a set of permissible operations for utilizing the resource by the second user. A role associated with the first user enables the first user to define the role for the second user. The first user customizes a user interface for the second user based on the role defined for the second user. The user interface for the second user provides the second user customized access to the resource.

### FIELD OF THE INVENTION

The present invention generally relates to provisioning of resources for users in a computer network, and, more particularly, to customizing access to the provisioned resources for the users in the computer network.

### BACKGROUND OF THE INVENTION

With increasing proliferation of computer networks and improved means of communication between the computer networks, resources such as softwares, business solutions and business applications may be shared and accessed remotely in a secure manner. Applications hosted on the World Wide Web, also referred to as web hosted applications, provide business users with a cheaper alternative of serving their computing needs. The web hosted applications preclude the business users from buying expensive commercially licensed versions of software and from investing in deployment and maintenance of the software for provisioning the application to its users. The web hosted applications may be accessed by the business users using a web browser installed on a computational device of the business users. Typically, applications such as email, video conferencing, accounting and the like, may be hosted on the web for being accessed by the business users for serving typical business functions.

Service providers, such as an internet service provider, may host the web hosted applications for serving users such as small businesses and resellers. Application vendors may also benefit from the web hosted applications as, in addition to being a cheaper alternative, the users such as the small businesses may access the web hosted applications from one or more remote locations. Further, the web hosted applications may be centrally updated at a service provider location instead of being updated on the computational device of each user. However, providing access to a hierarchy of users including small businesses, resellers and end-users may be challenging for the service providers.

Typically, the service providers offer the resource such as the web hosted applications with default customization and the users in the hierarchy customize their own user interface for accessing the resource and utilizing one or more features of the resource. This may be undesirable for business purposes, as it precludes business owners from controlling access to various features of the resource. For instance, a user at a higher level in the hierarchy may desire provisioning restricted access to users at a lower level in the hierarchy.

Accordingly, there exists a need for provisioning access to a resource for users in a hierarchy. Further, there exists a need for customizing access to the resource for users in the hierarchy. Furthermore, there exists a need for enabling a user at a higher level in the hierarchy to customize access to the resource for users at a lower level in the hierarchy.

### SUMMARY OF THE INVENTION

An object of the present invention is to provision access to a resource for users in a hierarchy.

Another object of the present invention is to customize access to a resource for users in a hierarchy.

Yet another object of the present invention is to enable a user at a higher level in the hierarchy to customize access to the resource for users at lower levels in the hierarchy.

In view of the foregoing disadvantages inherent in the prior art, the general purpose of the present invention is to customize access to a resource for users in a hierarchy that is configured to include all advantages of the prior art, and to overcome the drawbacks inherent therein. In an aspect of the present invention, a method is provided for customizing access to the resource. The access to the resource is requested by the users in a hierarchy. A first user of the users in the hierarchy is at a higher level in the hierarchy than a second user of the users in the hierarchy. The method includes defining a role by the first user for the second user. The role includes a set of permissible operations for utilizing the resource by the second user. A role associated with the first user enables the first user to define the role for the second user. The method further includes customizing a user interface by the first user for the second user based on the role defined for the second user. The user interface for the second user provides the second user customized access to the resource.

In another aspect of the present invention, a system for customizing access to a resource is provided. The access to the resource is requested by users in a hierarchy. A first user of the users in the hierarchy is at a higher level in the hierarchy than a second user of the users in the hierarchy. The system includes a role definition module, a customization module and a transceiver module. The role definition module enables the first user to define a role for the second user. The role includes a set of permissible operations for utilizing the resource by the second user. A role associated with the first user enables the first user to define the role for the second user using the role definition module. The customization module enables the first user to customize a user interface for the second user based on the role defined for the second user. The transceiver module provides a customized user interface to the second user. The user interface provides the second user customized access to the resource.

In yet another aspect of the present invention, a computer program product embodied on a computer readable medium is provided for customizing access to a resource. The access to the resource is requested by users in a hierarchy. A first user of the users in the hierarchy is at a higher level in the hierarchy than a second user of the users in the hierarchy. The computer program product includes a program module having instructions for defining a role by a first user of the users in the hierarchy for a second user of the users in the hierarchy. The role includes a set of permissible operations for utilizing the resource by the second user. A role associated with the first user enables the first user to define the role for the second user. The computer program product also includes a program module for customizing a user interface by the first user for the second user based on the role defined for the second user. The user interface provides the second user customized access to the resource.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 represents an environment in which various embodiments of the present invention may be practiced;

FIG. 2 illustrates a system for customizing access to a resource for users in a hierarchy, in accordance with an embodiment of the present invention;

FIG. 3 is a flow diagram illustrating a method for customizing access to a resource for users in a hierarchy, in accordance with an embodiment of the present invention; and

FIG. 4 illustrates an exemplary hierarchy of users for accessing a resource, in accordance with an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method, a system and a computer program product for customizing access to a resource. The access to the resource is requested by users in a hierarchy. A first user of the users in the hierarchy is at a higher level in the hierarchy than a second user of the users in the hierarchy. The first user defines a role for the second user. The role includes a set of permissible operations for utilizing the resource by the second user. A role associated with the first user enables the first user to define the role for the second user. The first user customizes a user interface for the second user based on the role defined for the second user. The user interface for the second user provides the second user customized access to the resource.

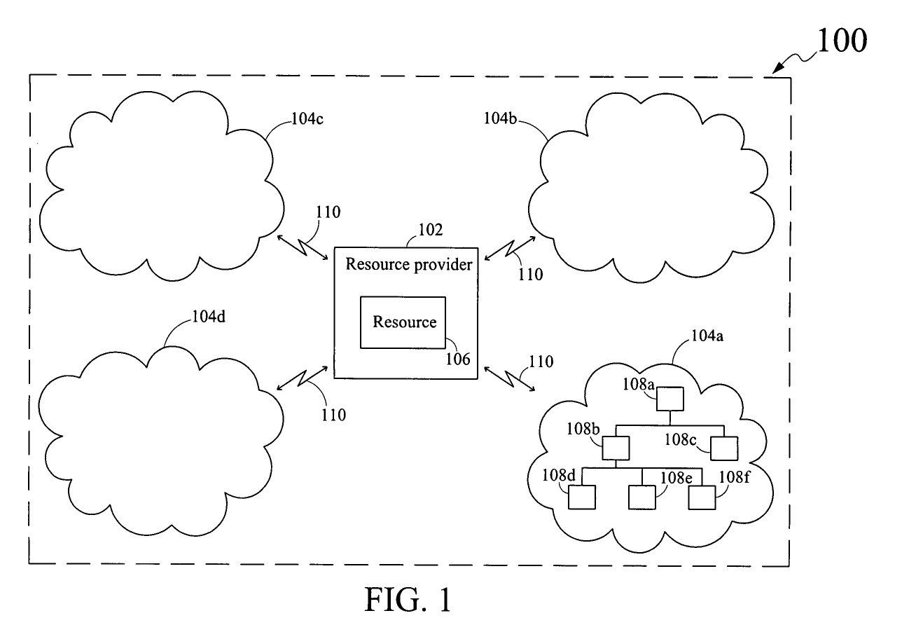

FIG. 1 represents an environment 100 in which various embodiments of the present invention may be practiced. The environment 100 includes a resource provider 102 and one or more entities such as an entity 104a, an entity 104b, an entity 104c and an entity 104d. The one or more entities such as the entities 104a, 104b, 104c and 104d will hereinafter be collectively referred to as plurality of entities 104. The resource provider 102 includes a resource 106. Each of the plurality of entities 104 includes one or more users (shown only for the entity 104a). The one or more users in each of the plurality of entities 104 may be arranged in a hierarchical arrangement. One such hierarchical arrangement of the one or more users is depicted for the entity 104a in FIG. 1. The entity 104a includes a user 108a, a user 108b, a user 108c, a user 108d, a user 108e and a user 108f. The user 108a is depicted to be at a higher level in the hierarchical arrangement than the user 108b and the user 108c. The user 108b and the user 108c are at a lower level in the hierarchical arrangement than the user 108a. The user 108d, the user 108e and the user 108f are at a bottom position in the hierarchical arrangement and at a lower level in the hierarchical arrangement than the user 108b and the user 108c.

The hierarchical arrangement is depicted for exemplary purposes and it will be evident to those skilled in the art that the entity 104a may include a greater number of users or a fewer number of users arranged in the hierarchical arrangement than the depicted number of users. Further, it will be obvious to a person skilled in the art, that the hierarchical arrangement is depicted to have a simplified configuration, and that the plurality of entities 104 may include increasingly complex arrangements for configuring the hierarchical arrangement.

The one or more users of the plurality of entities 104, hereinafter referred to as users, may request access to the resource 106 from the resource provider 102. An example of the resource provider 102 may be an Internet Service Provider (ISP). Examples of the resource 106 may include but are not limited to a Voice over Internet Protocol (VOIP) solution, a Blackberry service, an emailing application and the like. An example of an entity, such as the entity 104a, may be an organization. Examples of the users may include employees of an organization, resellers, third party vendors and the like. The request for the resource 106 may be communicated over a communication channel 110, such as a wireless medium, a wired medium or a combination thereof. In one embodiment of the present invention, a user may request access to the resource 106 using a web browser installed on a computational device of the user. Examples of the web browser may include an Internet Explorer web browser, a Mozilla web browser, a Netscape web browser and the like.

The access to the resource 106 may be customized for each user. In the hierarchical arrangement, users at the higher level in the hierarchical arrangement may customize access to the resource 106 for users lower in the hierarchical arrangement. In one embodiment of the present invention, the one or more users in the entity 104a request access to the resource 106 from the resource provider 102. The resource provider 102 and the users in the entity 104a configure a hierarchical arrangement, hereinafter referred to as hierarchy, for accessing the resource 106. The resource provider 102 serves as a topmost user in the hierarchy and may customize access to the resource 106 for the user 108a. The user 108a may customize access to the resource 106 for the user 108b and the user 108c. The user 108b may similarly customize access to the resource 106 for the user 108d, the user 108e and the user 108f.

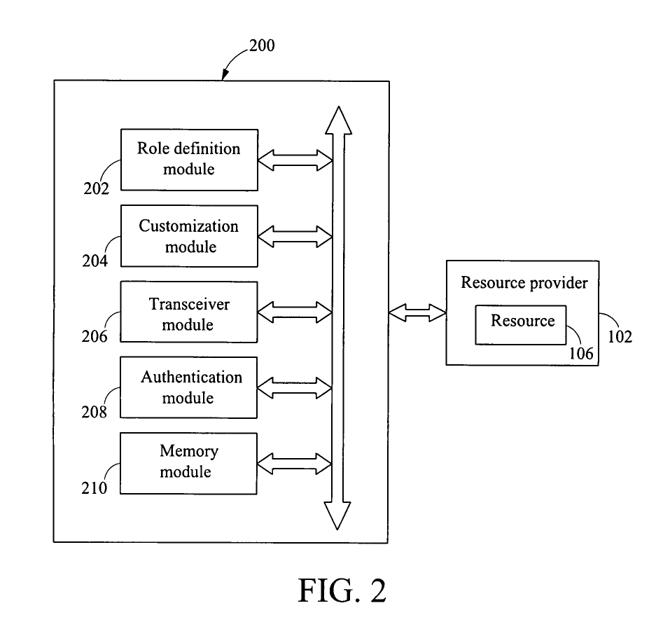

For purposes of the description, a user in the hierarchy may be a first user with regard to the users in the hierarchy when the user is at a higher level in the hierarchy than the users in the hierarchy. Similarly, the user in the hierarchy may be a second user with regard to the users in the hierarchy when the user is at a lower level in the hierarchy than the users in the hierarchy. For instance, the user 108a may be the first user for users at lower levels in the hierarchy than the user 108a, but the user 108a may be the second user with regard to the resource provider 102, since the user 108a is at the lower level in the hierarchy than the resource provider 102. It will be obvious to those skilled in the art that the user may be the first user or the second user depending on whether the user is placed at the higher level in the hierarchy or at the lower level in the hierarchy with regard to the users in the hierarchy. The first user may customize access to the resource 106 for the second user. Customizing access to the resource 106 will be explained in detail in conjunction with FIG. 2.

FIG. 2 illustrates a system 200 for customizing access to the resource 106, in accordance with an embodiment of the present invention. The system 200 may be communicably coupled with the resource 106 for customizing access to the resource 106 for the users in a hierarchy, such as the hierarchy explained in conjunction with FIG. 1. The system 200 includes a role definition module 202, a customization module 204, a transceiver module 206, an authentication module 208 and a memory module 210. As explained in conjunction with FIG. 1, a user at a higher level in the hierarchy of users, i.e. the first user, may customize access to the resource 106 for a user at a lower level in the hierarchy, i.e. the second user. The first user may use various modules of the system 200 for customizing access to the resource 106 for the second user.

The first user (not shown) may define a role for the second user (not shown) using the role definition module 202. The role includes a set of permissible operations for utilizing the resource 106. Referring to FIG. 1, the resource provider 102, i.e. the first user, may define a role for the user 108a, i.e. the second user, using the role definition module 202. The role may include a set of permissible operations for utilizing the resource 106 by the user 108a. Using the role definition module 202, the user 108a, i.e. the first user, may define roles for users lower in the hierarchy, i.e. the second users. The role definition module 202 may assign a predefined role to a topmost user in the hierarchy such as the resource provider 102.

In one embodiment of the present invention, the role associated with the first user provides the first user absolute access to the resource 106 when the first user is the topmost user in the hierarchy. The resource provider 102, thus, may be associated with a role providing absolute access to the resource 106. Since the topmost user in the hierarchy may be assigned a predefined role and the role may be defined for each user in the hierarchy by users at higher levels in the hierarchy, it will obvious to a person skilled in the art that each user in the hierarchy, including the topmost user in the hierarchy, may be associated with a role. The role associated with the first user may be defined by the users at the higher level in the hierarchy than the first user when the first user is other than the topmost user in the hierarchy. For instance, the role associated with the user 108a, i.e. the first user with regard to users at the lower level in the hierarchy, may be defined by the resource provider 102. The role associated with the first user defines the set of permissible operations for utilizing the resource 106 by the first user. Based on the role associated with first user, the first user defines a role for the second user.

The first user may customize a user interface (not shown) for the second user using the customization module 204. The user interface may be customized based on the role defined for the second user. In one embodiment of the present invention, the user interface may be a Graphical User Interface (GUI) including a default content and a customizable content. Customizing the user interface may include customizing the customizable content included in the GUI. The customizable content may include permissible operations that may be performed by the users in the hierarchy for utilizing the resource 106.

The permissible operations for utilizing the resource 106 may be referred to as events. For instance, a permissible operation of the permissible operations for utilizing the resource 106 may permit the first user to add the second user to the first user. The permissible operation permitting addition of the user may be represented as an ‘add user’ event. Similar events may be defined for representing the permissible operations for utilizing the resource 106. Examples of similar events may include ‘remove user’, ‘edit user’, ‘disable user’ and such other events. In one embodiment of the present invention, related events such as the ‘add user’, the ‘remove user’, the ‘edit user’ and the ‘disable user’ may be grouped to configure an event group ‘user actions’ to represent the one or more operations for utilizing the resource 106. The role defined by the first user for the second user may be associated with one or more events representing the set of permissible operations for utilizing the resource 106 by the second user. In one embodiment of the present invention, the role defined by the first user for the second user may be associated with an event group such as the event group ‘user actions’, representing the set of permissible operations for utilizing the resource 106.

Based on the role defined for the second user, the customization module 204 may configure the GUI to display the set of permissible operations, i.e. the permissible operations rendered admissible by the role defined by the first user for the second user. In one embodiment of the present invention, customizing the user interface may include concealing one or more permissible operations of the permissible operations, i.e. the permissible operations rendered inadmissible by the role defined for the second user. Concealing the one or more permissible operations may include masking GUI widgets and GUI items associated with the one or more permissible operations, such that the one or more permissible operations may be invisible to the second user. In one embodiment of the present invention, the customization module 204 may configure the GUI based on a previous selection of a permissible operation of the set of permissible operations by the second user. For instance, on selection of concealing the permissible operation for the event ‘add user’ by the first user for the second user, the customization module 204 may hide the GUI widgets and the GUI items associated with events related to the ‘add user’ event, such as the events ‘edit user’ and ‘disable user’ from the GUI provided to the second user. Thus the customization module 204 may be capable of customizing the GUI based on a previous event.

In another embodiment of the present invention, customizing the user interface may include disabling hyperlinks and access to customized pages for the one or more permissible operations rendered inadmissible by the role defined for the second user. A message ‘Access denied’ may be displayed to the second user on attempting to access the one or more permissible operations, i.e., the operations rendered inadmissible by the role defined for the second user.

The user interface provides the second user customized access to the resource 106. In one embodiment of the present invention, the customization module 204 may include provisioning Application Programming Interfaces (APIs) for providing a programmatic interface to configure the user interface for providing customized access to the resource 106.

The transceiver module 206 may be configured to provide the user interface to the second user for providing customized access to the resource 106. In one embodiment of the present invention, the transceiver module 206 may be configured to receive requests for accessing the resource 106 from the users in the hierarchy. The request may be received in form of a user identification information. Examples of the user identification information may include a user login name, a user password or any such other user identifying information. A user requesting access to the resource 106 may provide the user identification information to the transceiver module 206 using a web browser such as the web browser explained in conjunction with FIG. 1. Each request for accessing the resource 106 may be directed by the transceiver module 206 to the authentication module 208 for verifying the authenticity of the user requesting the resource 106. The authentication module 208 may be implemented using typical authorization and authentication tools such as Active Directory. On verifying the authenticity of the user requesting the resource 106, the transceiver module 206 may provide the user interface to the requesting user for accessing the resource 106.

The user identification information may be stored in the memory module 210 and may be retrieved by the authentication module 208 for verifying the authenticity of the requesting user. The memory module 210 may also store information on roles, hereinafter referred to as role information, associated with each user in the hierarchy of users. The role information associates roles defined for the each user with the user identification information of the each user. The roles defined for the each user may be stored in the memory module 210 in at least one Access Control List (ACL), such that the each user is associated with the at least one ACL including the role associated with the each user. Thus, the role defined by the first user for the second user may be stored in at least one ACL. The first user may similarly be associated with at least one ACL including the role associated with the first user. On verification of the user identification information provided by the first user, the role information associated with the user identification information may retrieve the at least one ACL associated with the first user and provide the user interface customized based on the role included in the at least one ACL. The first user may then define a role for the second user which may be stored in an ACL associated with the user identification information of the second user in the memory module 210. On requesting access to the resource 106 by the second user by providing the user identification information of the second user, the user interface customized based on the role included in the ACL associated with the second user's user identification information may be provided to the second user for utilizing the resource 106. In one embodiment of the present invention, each user is associated with the at least one ACL associated with the each user and the at least one ACL including roles defined by the each user for users at the lower level in the hierarchy.

In one embodiment of the present invention, the memory module 210 may store the events representing the permissible operations for utilizing the resource 106. The events may be stored in the memory module 210 in form of a configuration file or a database. The memory module 210 may also be capable of pluggable ACLs, roles, and one or more events defined by an external entity (not shown) such as a resource developer, third party resource vendors, resellers and the like. The memory module 210 may include a database (not shown) for storing the at least one ACL, the roles defined for the users, and the events representing the permissible operations for utilizing the resource 106. In one embodiment of the present invention, the system 200 may include web service APIs for providing the resource developers, the third party resource vendors and the resellers, programmatic access for configuring one or more modules of the system 200. The programmatic access may provide entities such as the resource developers, the third party resource vendors and even external entities such as online sign-up portals to automate processes such as flow-through provisioning, service billing and the like.

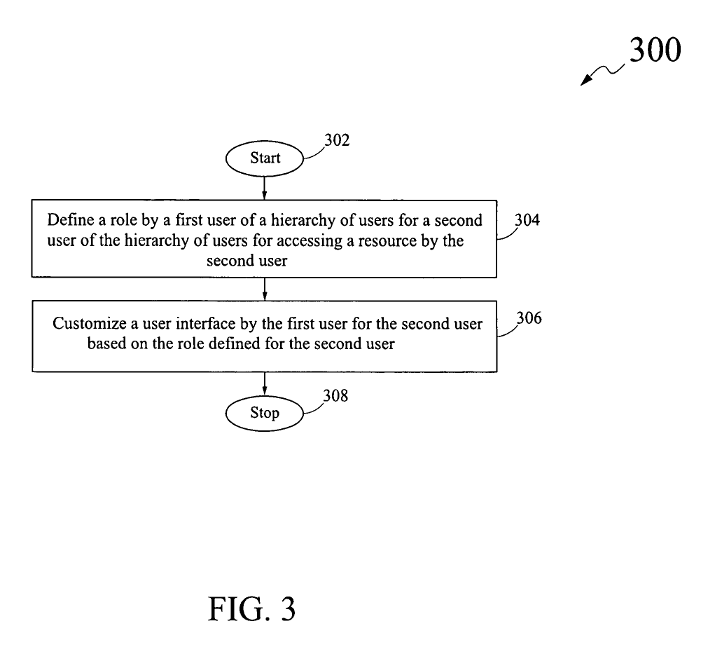

The system 200 may be implemented in a data processing device, such as a server, at a resource provider location (not shown) or any remote location capable of being accessed by the users in the hierarchy. It will be evident to those skilled in the art that each module of the system 200 such as the role identification module 202, the customization module 204, the transceiver module 206, the authentication module 208 and the memory module 210 may be implemented as a hardware module, a software module, a firmware module or any combination thereof. Further, it will obvious to a person skilled in the art that the system 200 may include a processing module for execution of instructions received by the system 200, and a battery unit for providing requisite power supply to the system 200. Furthermore, it will be obvious to those skilled in the art that the system 200 may include requisite electrical connections for communicably coupling the various modules of the system 200. A flow diagram illustrating the method for customizing access to the resource 106 for the users in the hierarchy is explained in conjunction with FIG. 3.

FIG. 3 is a flow diagram 300 illustrating a method for customizing access to the resource 106 for users in the hierarchy (explained in conjunction with FIG. 1), in accordance with an embodiment of the present invention. As explained in conjunction with FIGS. 1 and 2, the first user i.e. a user higher in the hierarchy than the second user, customizes access to the resource 106 for the second user. The flow diagram 300 starts at 302. At 302, the first user provides user identification information, such as the user login name and the user password, to the system 200 to receive the user interface for accessing the resource 106. The user interface is customized based on the role associated with the first user. At 304, the first user defines a role for the second user. At 306, the first user customizes the user interface for the second user based on the role defined for the second user. The method ends at 308. At 308, the second user accesses the resource 106 using the user interface customized by the first user.

As explained in conjunction with FIGS. 1 and 2, each user of the users in the hierarchy is associated with a role. The topmost user in the hierarchy may be associated with a predefined role such as a role providing absolute access to the resource 106. Users at lower levels in the hierarchy than the topmost user may be associated with roles defined by the users at the higher levels in the hierarchy. In one embodiment of the present invention, the first user may add the second user prior to defining the role for the second user. The first user may add the second user to the first user based on a roletype of the role associated with the first user. The roletype of the role of the first user in the hierarchy may determine the users that may be added to the first user. The roletype associated with the role may be stored in the memory module 210 of the system 200 and may be retrieved using the role information associated with the user identification information. For instance, a roletype of a role associated with the first user may be a reseller roletype. The reseller roletype may be pre-defined in the system 200 to enable the first user to add the second user of a subreseller roletype, an organization roletype or a user roletype. The role associated with the first user may include a set of permissible operations for enabling the first user to add the second user of the subreseller roletype, the organization roletype or the user roletype. Accordingly, the role associated with first user may include a reseller role for adding the second user of the reseller roletype, the organization role for adding the second user of the organization roletype and the user role for adding the second user of the user roletype. The first user may then accordingly add the second user of the reseller roletype, the second user of the organization roletype and/or the second user of the user roletype. The role defined for the second user by the first user may include the set of permissible operations corresponding to the roletype of the second user.

Referring to FIG. 1, the user 108a may add the user 108b and the user 108c prior to defining roles for the user 108b and the user 108c based on the roletype of the role of the user 108a. The roles defined for the user 108b and the user 108c may be based on the roletype of the role of the user 108a. The user 108b may add one or more users such as the user 108d, the user 108e and the user 108f based on the roletype of the user 108b. Thus, the first user, such as the user 108a, may add one or more users, i.e. second users based on the roletype of the first user for configuring the hierarchy of users. The first user may add the second user to the first user and may then define the role using the role definition module 202, explained in conjunction with FIG. 2, for the second user. The role defined for the second user by the first user may be based on the role associated with the first user. Based on the role (and associated roletype), the second user may add one or more users to the second user.

In one embodiment of the present invention, a permissible operation of the permissible operations explained in conjunction with FIG. 2, may enable granting roles to users at the lower level in the hierarchy. The permissible operation may be implemented in form of a logical variable capable of assuming one of a ‘true’ state and a ‘false’ state. The logical variable set to the true state may enable a user of the users in the hierarchy to define roles for the users at the lower levels in the hierarchy than the user. The logical variable set to the false state may preclude the user from defining the roles for the users at the lower levels in the hierarchy than the user. In an alternative embodiment of the present invention, the logical variable set to the true state is defined to preclude the user from defining the roles for the users at the lower levels in the hierarchy than the user and the logical variable set to the false state enables the user to define the roles for the users at the lower levels in the hierarchy than the user. It will be evident to a person skilled in the art that the permissible operation may be implemented in form of a menu option, a hyperlink and the like.

The first user may set the logical variable in the role defined for the second user to one of the true state and the false state. The logical variable may be set to one of the true state and the false state based on the roletype associated with the role defined for the second user. The first user may set the logical variable to the true state for enabling the second user to define the roles for the users at the lower level in the hierarchy than the second user. Alternatively, the first user may set the logical variable to the false state for precluding the second user from defining the roles for the users at the lower level in the hierarchy than the second user. In one embodiment of the present invention, the users added to the second user may then inherit the role defined for the second user, when the logical variable of the second user is set to the false state. In another embodiment of the present invention, the users added to the second user are associated with pre-defined default roles defined by the resource developer, explained in conjunction with FIG. 2, when the logical variable of the second user is set to the false state.

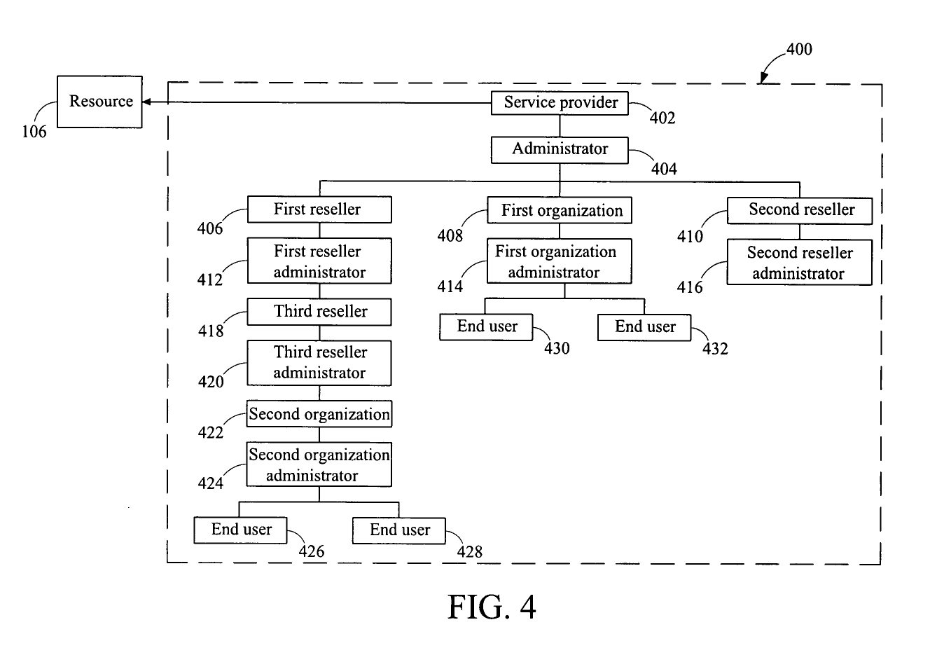

In one embodiment of the present invention, the first user may define a role for one or more users at the lower level in the hierarchy than the first user. A user interface may accordingly be customized for each user of the users at the lower levels in the hierarchy based on the role defined by the first user for customizing access to the resource 106 for the users at the lower levels in the hierarchy. Customizing access to the resource 106 by users in an exemplary hierarchy will be explained in conjunction with FIG. 4.

FIG. 4 illustrates an exemplary hierarchy 400 of users for accessing the resource 106, in accordance with an embodiment of the present invention. A service provider 402, such as the resource provider 102 explained in conjunction with FIG. 1, may be configured with absolute access to the resource 106. It will be obvious to a person skilled in the art that absolute access to the resource 106 may include the permissible operations for utilizing the resource 106. The service provider 402 may provision access to the resource 106 using a system such as the system 200 explained in conjunction with FIG. 2. The access to the resource 106 may be requested by users such as resellers, organizations, end-users and the like. Roletypes such as the roletype explained in conjunction with FIG. 3 may be defined for adding users requesting access to the resource 106. Since the access to the resource 106 is requested by the users such as the resellers, the organizations and the end-users, the roletypes such as a reseller roletype, an organization roletype and an end user role type may be defined. The reseller roletype may enable a user to add users such as subresellers, organizations and end users. The organization roletype may enable the user to add end users. The end users roletype may preclude the user from adding users. Each roletype may be assigned roles. For instance, the end user roletype may include the roles such as a read-only access role, a restricted access role, a default role and the like.

The service provider 402 may configure an administrator 404 for provisioning access to the users and may set a logical variable (such as the logical variable explained in conjunction with FIG. 3) to a true state for enabling the administrator 404 for defining roles for the users added to the administrator 404. The administrator 404 may add a first reseller 406 of the reseller roletype, a first organization 408 of the organization roletype and a second reseller 410 of the reseller roletype. The first reseller 406 may configure a first reseller administrator 412 for adding users and defining roles for the users. Similarly, the first organization 408 may configure a first organization administrator 414, and, the second reseller 410 may configure a second reseller administrator 416 for adding users and defining roles for the users. The administrator 404, i.e. the first user defines role for each of the first reseller 406, the first organization 408 and the second reseller 410, i.e. the second user.

Based on the role defined by the administrator 404, the first reseller administrator 412, the first organization administrator 414 and the second reseller administrator 416 may each receive a user interface providing customized access to the resource 106. The administrator 404 may be associated with a role associating the administrator 404 with absolute access to the resource 106. The administrator 404 may define roles for each of the first reseller 406, the first organization 408 and the second reseller 410, such that the first reseller 406, the first organization 408 and the second reseller 410 are provided the user interface permitting access to the set of permissible operations rendered admissible to the first reseller 406, the first organization 408 and the second reseller 410, respectively. The administrator 404 may further set the logical variable to the true state for each of the reseller 406, the first organization 408 and the second reseller 410 for enabling the first reseller administrator 412, the first organization administrator 414 and the second reseller administrator 416 to define the roles for the users at the lower levels in the hierarchy than the first reseller administrator 412, the first organization administrator 414 and the second reseller administrator 416.

The first reseller 406 includes a role associated with the reseller roletype and may add users such as subresellers, organizations and end-users. The first reseller administrator 412 may add a third reseller 418 of the reseller roletype. The third reseller 418 may configure a third reseller administrator 420 for adding users and defining roles for the users. The first reseller administrator 412 may define a role for the third reseller 418, such that the third reseller 418 is provided the user interface permitting access to the set of permissible operations rendered admissible to the third reseller 418. The first reseller administrator 412 may further set the logical variable to the true state for the third reseller 418 for enabling the third reseller administrator 420 to define the roles for the users at the lower levels in the hierarchy than the third reseller administrator 420.

The third reseller 418 includes a role associated with the reseller roletype and may add users such as subresellers, organizations and end-users. The third reseller administrator 420 may add a second organization 422 of the organization roletype and may define a role for the second organization 422. The third reseller administrator 420 may set the logical variable of the second organization 422 to the false state for precluding the second organization 422 from defining the roles for the users at the lower levels in the hierarchy than the second organization 422. Based on the role defined for the second organization 422 by the third reseller administrator 420, the second organization 422 may be provided a user interface customized for accessing the resource 106.

Based on the organization roletype, the second organization 422 may add end users to the second organization 422. The second organization 422 may configure a second organization administrator 424 for adding end users to the second organization 422. The second organization administrator 424 may accordingly add an end user 426 and an end user 428 to the second organization 422. The role associated with the organization roletype defined for the second organization 422 may include a set of permissible operations for providing a restricted access role to the end user 426 and the end user 428. Since the logical variable of the second organization 422 is set to the false state precluding the second organization administrator 424 from defining the roles (other than the role including the set of permissible operations for providing restricted access), the roles for the end user 426 and the end user 428 may accordingly be the restricted access role. Based on the role defined for the end user 426 and the end user 428, each of the end user 426 and the end user 428 may be provided a user interface providing restricted access to the resource 106. The user interface provided to the end user 426 and the end user 428 may conceal the one or more permissible operations, i.e. the operations rendered inadmissible to the end user 426 and the end user 428 by respective roles of the end user 426 and the end user 428.

The first organization administrator 414 may similarly add an end user 430 and an end user 432 to the first organization 408. The logical variable of the first organization administrator 414 may be set to the true state by the administrator 404 and the role associated with the organization roletype may include a set of permissible operations for providing default access to users added to the first organization 408. Since the logical variable of the first organization 408 is set to the true state enabling the first organization administrator 414 to define roles (other than role including set of permissible operations for providing default access), the roles for the end user 430 and the end user 432 may accordingly be defined as a read-only access role and a restricted access role.

It will be evident to those skilled in the art that the exemplary hierarchy 400 including the service provider 402, the first reseller 406, the first organization 408, the second reseller 410, the third reseller 418, the second organization 422, and end users such as the end user 426, the end user 428, the end user 430 and the end user 432 is depicted for exemplary purposes and that different configurations of hierarchy may be possible. Moreover, users accessing the resource 106 may not be limited to the resellers, the subresellers, the organizations and the end users.

Referring to the exemplary hierarchy 400, it will be obvious to a person skilled in the art that administrators at every level in the hierarchy may have access rights to customize the user interface for all levels lower in the hierarchy than the administrator. For instance, the third reseller administrator 420 may be capable of configuring customization features for levels in the hierarchy lower than the third reseller 418, i.e. the second organization 422, the end user 426 and the end user 428. The administrators at every level in the hierarchy may define roles including set of permissible operations for utilizing the resource 106 for users at all levels lower in the hierarchy than the respective administrators. Further, administrators at every level in the hierarchy may define the roletypes and the roles for the users that may be added to the respective administrators. For instance, the third reseller administrator 420 may define the roletypes such as marketing, operations and the like, and define roles for the users for the defined roletypes. The roles and the roletypes defined by administrators at every level in the hierarchy may be stored in a memory module, such as the memory module 210 of the system 200, explained in conjunction with FIG. 2.

In one embodiment of the present invention, an administrator at a lower level, such as the second organization administrator 424 may request an administrator at a higher level such as the third reseller administrator 420 for additional set of permissible operations than those included in the role defined for the second organization 422. In one embodiment of the present invention, the request may be placed to an administrator at a higher level in the hierarchy by an administrator at the lower level in the hierarchy through the user interface provided to the administrator at the lower level in the hierarchy by the administrator at the higher level in the hierarchy.

Customizing access to a resource, such as the resource 106, for users in a hierarchy by utilizing a system, such as the system 200, provides better provisioning of the resource to the users. A first user, such as the first user explained in conjunction with FIG. 1, may be referred to as a parent and the second user, such as the second user may be referred to as a child. As explained in conjunction with FIGS. 2, 3 and 4, the parent may define a role and customize a user interface for the child for providing access to the resource for the child. Thus, the parent may have better control over permissible operations for utilizing the resource that may be provisioned to the child associated with the parent. The parent may further delegate administration, i.e. provisioning access to the resource, by defining a logical variable in the role for the child. The user interface may further be configured to display only those features which are rendered admissible to the child by the roles defined by the parent. An overhead involved in servicing requests from the child for accessing one or more permissible operations rendered inadmissible to the child may be reduced, thereby, improving processing time for servicing requests for utilizing the resource.

As described above, the embodiments of the present invention may be embodied in the form of computer-implemented processes and apparatuses for customizing access to the resource. Embodiments of the present invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the present invention. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A method for customizing access to a resource, the access to the resource requested by users in a hierarchy, the method comprising:
defining a role by a first user of the users in the hierarchy for a second user of the users in the hierarchy, the role comprising a set of permissible operations for utilizing the resource by the second user; and
customizing a user interface by the first user for the second user based on the role defined for the second user, wherein the user interface provides the second user customized access to the resource,
wherein the first user has a higher level in the hierarchy than the second user, and,
wherein a role associated with the first user enables the first user to define the role for the second user.

2. The method of claim 1, wherein the role associated with the first user provides the first user absolute access to the resource when the first user is a topmost user in the hierarchy.

3. The method of claim 1, wherein the role associated with the first user is defined by users at a higher level in the hierarchy than the first user when the first user is other than the topmost user in the hierarchy, the role comprising a set of permissible operations for utilizing the resource by the first user.

4. The method of claim 1, further comprising adding the second user to the first user by the first user prior to defining the role for the second user.

5. The method of claim 4, wherein the second user is added to the first user based on a roletype of the role associated with the first user.

6. The method of claim 1, wherein customizing the user interface comprises concealing one or more permissible operations rendered inadmissible by the role defined for the second user.

7. The method of claim 1, further comprising defining a role by the first user for one or more users of the users in the hierarchy, the one or more users at lower levels in the hierarchy than the first user.

8. A system for customizing access to a resource, the access to the resource requested by users in a hierarchy, the system comprising:
a role definition module for defining a role by a first user of the users in the hierarchy for a second user of the users in the hierarchy, the role comprising a set of permissible operations for utilizing the resource by the second user;
a customization module for customizing a user interface by the first user for the second user based on the role defined for the second user; and
a transceiver module for providing the user interface to the second user, wherein the user interface provides the second user customized access to the resource,
wherein the first user has a higher level in the hierarchy than the second user, and
wherein a role associated with the first user enables the first user to define the role for the second user.

9. The system of claim 8, wherein the role associated with the first user provides the first user absolute access to the resource when the first user is a topmost user in the hierarchy.

10. The system of claim 8, wherein the role associated with the first user is defined using the role definition module by users at higher levels in the hierarchy than the first user when the first user is other than the topmost user in the hierarchy, the role comprising a set of permissible operations for utilizing the resource by the first user.

11. The system of claim 8, further comprising a memory module for storing the role defined for the second user in at least one Access Control List (ACL).

12. The system of claim 11, wherein the memory module is capable of storing at least one of pluggable ACLs, roles and one or more operations defined by an external entity for utilizing the resource.

13. The system of claim 12, wherein the external entity is one of a resource developer and a third-party resource vendor.

14. The system of claim 8, wherein the customization module is capable of concealing one or more permissible operations rendered inadmissible by the role defined for the second user for customizing the user interface.

15. The system of claim 8, further comprising an authentication module for authenticating the second user for providing the user interface to the second user.

16. A computer program product embodied on a computer readable medium for customizing access to a resource, the access to the resource requested by users in a hierarchy, the computer program product comprising a program module having instructions for:
defining a role by a first user of the users in the hierarchy for a second user of the users in the hierarchy, the role comprising a set of permissible operations for utilizing the resource by the second user; and
customizing a user interface by the first user for the second user based on the role defined for the second user, wherein the user interface provides the second user customized access to the resource,
wherein the first user has a higher level in the hierarchy than the second user, and,
wherein a role associated with the first user enables the first user to define the role for the second user.

17. The computer program product according to claim 16, further comprising instructions for adding the second user to the first user by the first user prior to defining the role for the second user.

18. The computer program product according to claim 17, wherein the second user is added to the first user based on a roletype of the role associated with the first user.

19. The computer program product according to claim 16, wherein instructions for customizing the user interface comprise instructions for concealing operations rendered inadmissible by the role defined for the second user.

20. The computer program product according to claim 16, further comprising instructions for defining a role by the first user for one or more users of the users in the hierarchy, the one or more users at lower levels in the hierarchy than the first user.
